(19) United States
(12) Patent Application Publication
(10) Pub. No.: US 2004/0226205 A1
(43) Pub. Date: Nov. 18, 2004

(54) Lights-on headlight indicator for automobiles and trucks

(76) Inventor: Kevin Kawakita, Temple City, CA (US)

Correspondence Address: KEVIN KAWAKITA, 5812 TEMPLE CITY BL # 100, TEMPLE CITY, CA, 91780, US

(21) Appl. No.: 10/439,003

(22) Filed: May 15, 2003

(51) Int. Cl. G09F 21/04

(52) U.S. Cl. 40/593

(57) ABSTRACT

This invention consists in the preferred embodiment of a device consisting of a rubber cap for instrument stalk (104) with variable diameters for different car makes and models, one or more stalk extender sections (106) of standard diameter, a lights on label (108) saying ‘lights on!!!!’, a snap-on twistable end with ball shelf (112), a ball string (116), a ball string length adjustor (120), a fuzzy lights on ball (124), which is an add-on device to existing motor vehicles to give an indication of a driver leaving a vehicle with the head-lights left in the on position. A first alternative embodiment is specifically designed for indicating to the driver that sports equipment is still loaded overhead on a roof-top sport's rack.

### FIELD OF INVENTION

This invention relates to a mechanical add-on device for existing automobiles, trucks, recreational vehicles, and suburban vehicles to warn the driver of headlights on in the day-light especially for older makes and models with no electronic detection and electronic warning buzzer equipment.

### BACKGROUND

A need exists for an add-on product daylight headlight on indicator after automobile and truck ignitions are turned off to avoid unwanted battery draining while the driver is in or away from the vehicle and totally unaware that his headlights are still on draining battery power. The problem is especially acute after the driver leaves the vehicle with the headlights on especially in the daytime (e.g. after emerging to daylight from underground parking garages or in light daylight sprinkles or in light fog) and comes back to find that his vehicle will not start due to a drained battery. This situation happens often in the daytime after drivers exit underground parking structures with their headlights on, and also after daytime rain bursts or early morning fog requires use of headlights in the daytime. The often used but not standard for all makes and models right side, headlight control and turn indicator instrument stalk which often holds a twist-knob headlight control along with its tiny ‘active bar—OFF, PARKING, HIGH’ label (LO beams are often obtained by a stalk forward driver motion) which is often hidden from view by the driver by the steering wheel. The instrument stalk must be artificially extended by the invention to give instrument status with a label readable beyond the steering wheel without blocking driver entry and exit. Night-time incidents of headlights left on after drivers exit vehicles are rare because the headlight beams of light still activated are clearly noticeably by the driver when exiting the car.

Some makes and models of vehicles use an instrument panel light control rotary knob with a dimmer switch position. This invention was not intended for these makes and models. Recent makes with electronic vehicle computer head-light controls automatically turn the head-lights off at car ignition termination, not requiring this invention. Some makes and models of vehicles use a right stalk twist head-light control instead of a left-stalk twist head-light control. This invention will work with these makes and models in mirror-image design with the stalk twist label, but, without need for the hanging ball which hits the driver's leg upon door exit reminder only on left-stalk twist head-light controls. Some makes and models of older vehicles use an instrument panel series of radio type push buttons for head-light control. This invention will not work with these makes and models.

The device should be low-cost, post-factory equipped better known as an ‘add-on’ product as the main market is older make and older model vehicles with no electronic detection driver assists such as chimes or buzzers. The device should be energy efficient, should not interfere with any vehicle instrument use, and should not interfere with driver entry and exit from the vehicle.

A first alternative embodiment for the invention is for a warning indicator for overhead (roof-rack), vehicle sports rack users (e.g. Yakima (R ) or Thule (R )) warning them that their vehicle overhead clearance is greatly increased by bicycles, kayaks, sport's cargo containers, windsurfing boards, surf-boards. Overhead vehicle sports rack users carrying very tall overhead sports items such as bicycles, forget the items are there because they are out of driver's sight when inside the vehicle. The tragic result is that drivers quite often crash expensive sport's items such as two racing bicycles costing $1000 each into garage door lowered over-hangs. A ‘bicycles-on’ warning indicator would be greatly appreciated to warn them that their overhead car clearance is greatly increased when entering garages with low roofs and low overhead clearance parking structures.

### Public Domain Use

Almost every one of the latest model vehicles produced after 1990 have electronically controlled headlights under control of the car's engine computer. The headlights are automatically turned on during both the daytime and night-time for road safety purposes and automatically shut-off after the ignition is turned off.

Older vehicles produced before 1990 included lights-on headlight audible chiming or buzzer warnings when the driver's door is opened only in the luxury model makes for most brands. If the driver opened the driver's door and exited the vehicle with the headlight still on, a chiming circuit would start a chiming noise until the driver's side door was closed or the headlight was turned off. This chime would warn the driver of a headlight left on upon driver exit from the vehicle. The same chiming circuit would also warn the driver of a vehicle key still in the ignition upon driver exit from the vehicle. A driver's side door open spring-loaded electrical switch on the driver's door would open loop circuit trigger the chiming circuit only if either a separate loop circuit for the key in the ignition produced a closed circuit or else if a separate loop circuit for the headlight turned to the on position produced an open circuit.

Older vehicles produced before 1990 especially in the non-luxury models for most domestic US makes and foreign makes, had no chiming circuits to warn of headlights left on and vehicle keys left in the ignition switch upon driver's door opening and driver exit from the vehicle. Many of these vehicles are still in use on US roads. Many of these older vehicles are currently sent overseas for use in less developed countries.

Older vehicles produced before 1980 in both the luxury and non-luxury car models and truck models for all makes had no chiming circuits to warn of either headlights left on or else of vehicle keys left in the ignition switch upon driver door open and driver exit from the vehicle. Many of these older vehicles are valuable collector's items or antiques, memory lane collector's cars, and many are still in daily use in foreign countries.

There is still a need for an add-on product, lights-on headlight indicator for older vehicles produced before 1990 in the non-luxury car model classes for all makes. All vehicles of all makes and all models produced before 1980 can still use such an invention as the lights on problem is quite frequent and irritating for even the best of drivers resulting in a dead battery and a tow-truck call.

A 1st alternative for the invention is for use as an “in use indicator” for sports equipment on top of a car sport's roof rack or truck/ATV sports equipment roof rack or camping equipment vehicle/ATV roof rack. All prior art overhead roof racks with sports equipment in use indicator warnings are electronic in nature and must be built-in the vehicle by the auto manufacturer at the factory. The resulting problem of the driver not visibly seeing and forgetting about his over-head roof rack in use especially with tall objects such as racing bicycles is that he will drive the tall object directly into a low overhang such as his own garage door overhang or into a parking structure low overhang. The expensive sport's equipment can be destroyed with several thousand US dollar damage to the equipment and even to the vehicle's roof.

### U.S. Pat. No. 4,105,898

### Patent Issued To: Farler, et al.

### Patent Assigned To: None

### Patent Issue Date: Aug. 8, 1978

### Patent Application Filing Date: Sep. 19, 1975

This Farler patent concerns a combined automotive headlight control knob which incorporates not only on/parking lights on/headlight beam on, but, also hi-beam/low-beam control through an electrical interface.

The Farler patent is not related to my invention.

### U.S. Pat. No. 5,438,314

### Patent Issued To: Evans, Harold A.

### Patent Assigned To: None

### Patent Issue Date: Aug. 1, 1995

### Patent Application Filing Date: Mar. 31, 1993

This Evans patent concerns a turn indicator control mechanism with variable rates of turn flashing and and automatic turn flash shut-off after a vehicle turn is completed.

The Evans patent is not related to my invention.

### U.S. Pat. No. 6,012,736

### Patent Issued To: Hansen, et al.

### Patent Assigned To: Eaton Corporation (Cleveland, Ohio)

### Patent Issue Date: Jan. 11, 2000

### Patent Application Filing Date: Dec. 1, 1998

This Hansen patent concerns an electronic digital control circuit mechanism for use in a steering wheel control mechanism for multiple uses of air bag firing remotely triggered by the separate automobile crash sensor computer, turn indicators for turn indicator control, headlight control and hi/low beam activation, horn control.

The Hansen patent is not related to my invention.

### OBJECT AND ADVANTAGES OF ALL EMBODIMENTS

A. An object of the preferred embodiment is to be a post-factory equipped or add-on product.

B. An object of the preferred embodiment is to be an extremely low cost and easy to install add-on invention.

C. An object of the preferred embodiment is to not interfere in any way with vehicle instrument operation.

D. An object of the preferred embodiment is to not interfere in any way with driver entry and exit from the vehicle.

E. An object of the 1^{st} alternative embodiment is to act as a warning indicator for roof-top sports equipment racks warning the driver that sports equipment such as bicycles are mounted overhead which is not always obvious when they are hidden from driver's view.

F.

### SUMMARY

This invention in its preferred embodiment specifies a lights-on headlight indicator to the driver of vehicles. The invention will be especially useful to the drivers of older model (pre-1990), economy cars of all makes which do not have built-in electronic circuitry to accomplish this goal.

A 1^{st} alternative embodiment will warn drivers of vehicles using overhead mounted, vehicle sports racks that tall sports equipment items such as bicycles are stored overhead. This will help prevent collisions between the sports equipment and low overhead clearance spaces such as garage doors and low overhead parking structures.

### BRIEF DESCRIPTION OF THE DRAWINGS

FIG. 1 shows the preferred embodiment of the lights-on, headlight indicator, post-factory installed (‘add-on’) in a vehicle in the head lights on position.

FIG. 2 shows the preferred embodiment of the lights-on, headlight indicator, post-factory installed in a vehicle in the head lights-off position.

FIG. 3 shows the 1^{st} alternative embodiment of the “bicycles-on”, overhead sports rack loaded indicator post-factory installed in a vehicle in the “bicycles-on” position.

### LIST OF PART NUMBERS IN THE PREFERRED EMBODIMENT

100. Lights on Assembly

104. Rubber Cap for Instrument Stalk

different diameters supplied for different makes and models of cars on one end nearest the steering wheel with a standard diameter on the other end away from the steering wheel.

A kit of several caps will give the correct diameter for any make and model of car.

106. Stalk Extender Sections

plastic snap-on extender sections to extend a twist-control headlight control stalk beyond the steering wheel such that it is not hidden from line of sight by the particular drivers of the car

108. Lights on Label

is driver(s) line of sight visible amd fully driver readable with the head-light control twisted on and hidden from the driver and only partially driver readable when the head-light control is twisted off.

112. Snap-On Twistable End with Ball Shelf

The ball shelf is in a gravity countering horizontal shelf position dependent upon instrument stalk motion when the head-light control is twisted on and in a free-fall vertical shelf position dependent upon instrument stalk motion when the head-light control is twisted off. Holds the lights-on label (108).

116. Ball String

(optional) the adjustable length ball string attaches the fuzzy lights on ball (124) to the snap-on twistable end with ball shelf (112).

120. Ball String Length Adjustor

(optional) the figure eight string holder adjusts the length of the ball string (116).

124. The Fuzzy Lights-On Ball

(optional) the fuzzy lights on ball which has the ‘Lights On!!!!’ label is kept in the snap-on twistable end with ball shelf (112) when the headlight stalk control is twisted off. When the headlight stalk control is twisted-on, the fuzzy ball falls under gravity having the ball shelf in the gravity freefall position. The fuzzy lights-on ball will hit the driver's leg when he exits the vehicle with the driver's side door open. The driver will be reminded to turn off the headlights in daylight and he will return the fuzzy lights-on ball to the snap-on twistable end with ball shelf (112) with the ball shelf now in the gravity counter position.

### Additional Part Numbers Used Only in the 1^{ST} Alternative Embodiment

800. Bicycles on Assembly

804. Rubber Cap for Instrument Stalk

different diameters supplied for different makes and models of cars on one end nearest the steering wheel with a standard diameter on the other end away from the steering wheel.

A kit of several caps will give the correct diameter for any make and model of car.

812. Bicycles on Label

used instead of the “Lights On!!!!!!” label with the words, “Bicycles On!!!!!!”. Has the alternative meaning of sport's equipment (e.g. kayaks, surfboards, sport's container bins, travel bins) upon a sport's roof rack instead of bicycles.

816. Snap-On Extender for Two Label Use

enables optional use of an additional ‘lights-on’ label twist unit which is dependent upon instrument stalk twist position along with a ‘bicycles on’ label twist unit which is independent of the instrument stalk twist position.

820. Snap-On End with Ball Shelf

The ball shelf position is independent of the instrument stalk twist position. If the driver hand twists the unit to the gravity countering horizontal shelf position independent of the head-light control then the driver can place the ball on the shelf. If the driver hand twists the unit to the gravity free-fall vertical shelf position independent of the head-light control, then the ball will dangle and hit his leg upon car exit. Holds the bicycle on label (812).

### Not Part of the Invention

800. Vehicle Steering Wheel

804. Vehicle Left Control Stalk

usually used for headlights twist knob, right turn stalk up, left turn stalk down, high beam stalk forward, low beam stalk backwards. Different makes, models, and different years have different uses and different motions.

A right stalk kit or mirror-image part left stalk kit should work for any make or model of vehicle using instrument stalks.

812. Vehicle Right Control Stalk

usually used for wiper speed/intermittent wiper speed/on/off twist knob, cruise control speed up stalk up (spring loaded), cruise control speed down stalk down (spring loaded), cruise control on tip of stalk button in, front windshield washer fluid manual squirt is spring loaded stalk to front. Different makes, models, and different years have different uses and different motions. A right stalk kit or a mirror-image part left stalk kit should work for any make or model using instrument stalks.

816. Driver's Left Hand

820. Steering Wheel Horn

824.

### Detailed Description of and Operation of the Drawings—Preferred Embodiment

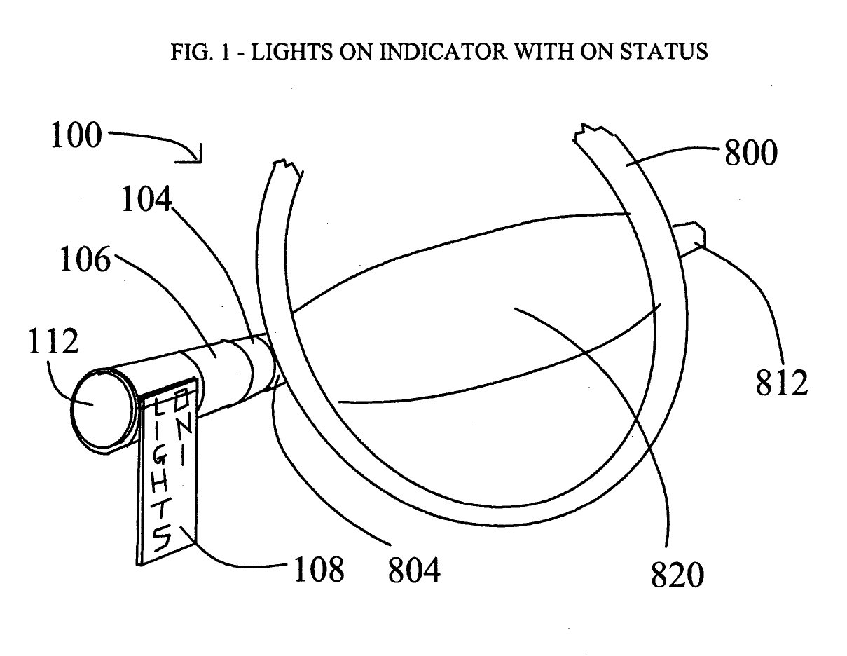

FIG. 1 shows the preferred embodiment of the lights-on, headlight indicator, post-factory installed in a vehicle in the lights-on position.

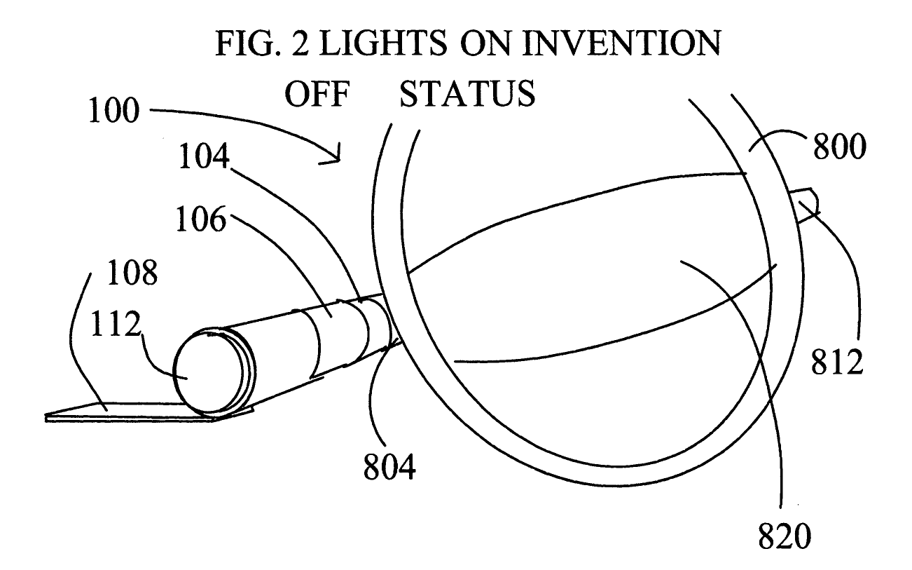

FIG. 2 shows the preferred embodiment of the lights-on, headlight indicator, post-factory installed in a vehicle in the lights-off position.

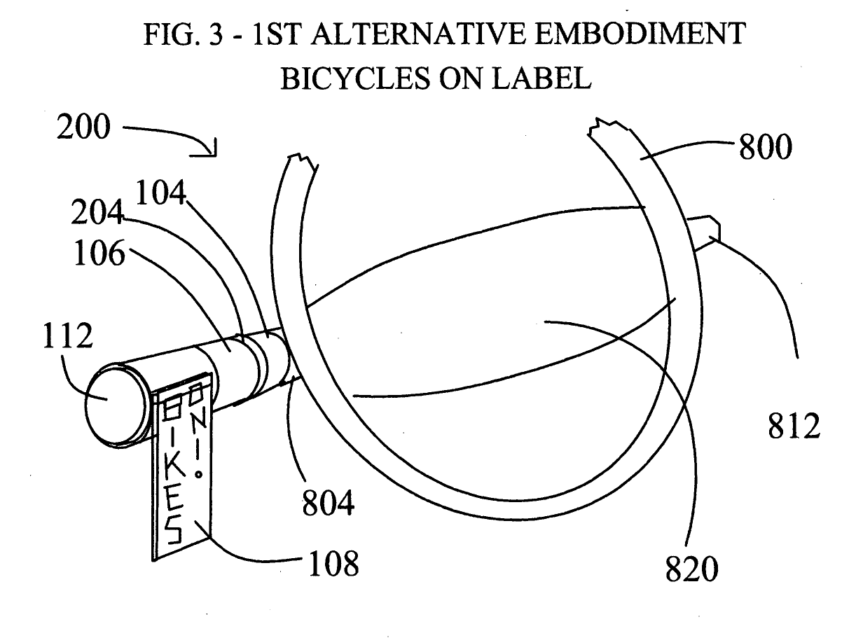

FIG. 3 shows the first alternative embodiment of the bicycles-on, overhead sports rack loaded indicator post-factory installed in a vehicle in the “bicycles-on” label showing warning position.

### Advantages of the Preferred Embodiment

A. An advantage of the preferred embodiment is to be an after factory-equipped or add-on product.

This advantage is accomplished by the rubber cap for instrument stalk (104) available in different stalk diameters for different makes and models of vehicles, the stalk extender sections (106), the lights on label (108), and the snap-on twistable end with ball shelf (112).

B. An advantage of the preferred embodiment is to be extremely low cost and easy to install.

This advantage is accomplished by the rubber cap for instrument stalk (104) available in different stalk diameters, the stalk extender sections (106), the lights on label (108), and the snap-on twistable end with ball shelf (112).

C. An advantage of the preferred embodiment is to not interfere in any way with instrument operation.

This is accomplished by the add-on nature of the invention. The mechanical placement of the invention is such that it does not interfere with driver movements.

D. An advantage of the preferred embodiment is to not interfere in any way with driver entry and exit from the vehicle.

The driver exit from the vehicle is deliberately interfered with only when the driver exits the vehicle with the head-lights still on as indicated by the fuzzy lights on ball (124) hitting his leg.

### Detailed Description of and Operation of the Drawings—1ST Alternative Embodiment

FIG. 3 shows the 1^{st} alternative embodiment of the bicycles-on overhead sports rack loaded indicator post-factory installed in a vehicle in the “bicycles-on” position.

This 1^{st} alternative embodiment for overhead sports rack in-use indication can be used on newer vehicles on the left driver stalk usually holding the headlight control (twist control) and the turn control (left turn is down and right turn is up), since, the engine control computer will do monitoring of vehicle headlights left on, and ignition keys left in the ignition conditions upon driver exit from the vehicle.

On older vehicles, this 1^{st} alternative embodiment for bicycle on label (812) or else with the dual meaning of overhead sports rack in-use indication can be used in addition to a preferred embodiment lights-on label (108) indicator if the snap-on extender for two label use (816) is used, The right side stalk is used for different things by different vehicle manufacturers. Usually the right side stalk twist action is used for windshield wiper and windshield washer fluid control.

### Advantages of the 1ST Alternative Embodiment

E. An advantage of the first alternative embodiment is to act as a warning indicator for roof-top sports equipment racks warning the driver that sports equipment such as bicycles are mounted overhead which is not always obvious when they are hidden from driver's view.

Many a roof-top sports equipment rack owner has lost two expensive racing bikes valued at $1000 a piece to a collision with a garage door opening or a low entry parking structure because he simply forgot that the bicycles were on top of his vehicle.

### Summary, Conclusions, Ramifications, & Scope

A. This invention in the preferred embodiment is an after factory-equipped or add-on product.

B. This invention in the preferred embodiment is extremely low cost and easy to install.

C. This invention in preferred embodiment does not interfere in any way with instrument operation.

D. This invention in the preferred embodiment does not interfere in any way with driver entry and exit from the vehicle.

E. This invention in the first alternative embodiment acts as a warning indicator for roof-top sports equipment racks warning the driver that sports equipment such as bicycles are mounted overhead which is not always obvious when they are hidden from driver's view.

Many a roof-top sports equipment rack owner has lost two expensive racing bikes valued at $1000 a piece to a collision with a garage door or a low entry parking structure because he simply forgot that the bicycles were on top of his vehicle.

F.

These descriptions serve as only a few examples of some of the many embodiments of the invention. Given this description, many other embodiments of the invention are possible and become obvious to a craftsman of average skill having knowledge of all prior art and public art. For example, the attachment position of the lights on label (108) upon the snap-on twistable end with ball shelf (112) can be changed from label sticking up from the front side to label sticking down from the front side to label sticking down from the back side to label sticking down from the back side. Different attachment positions have different implications for obstructing driver manual access and driver line of sight view access to instruments, for blocking driver view of the label by the steering wheel, for blocking driver view of the label by other instruments, as well as for interfering with easy driver entry and exit from the vehicle. Different materials may be used instead of rubber and plastic with different costs and durabilities especially regarding ultra-violet light and extreme heat break-down of materials. Schedule 40 poly-vinyl chloride (PVC) is designed for high ultra-violet light endurance which breaks down most plastic products over time. The left instrument stalk can be switched to the symmetric right instrument stalk with the use of mirror-image designed parts for the invention. A left side instrument stalk can be supplemented by a right side instrument stalk mirror-image product for additional use such as a sports roof-top rack indicator.

This description and the specific embodiments mentioned herein should not serve as a limitation of the number of embodiments under potential protection and coverage by this patent, rather, the accompanying patent claims shall serve as the sole means of deciding the scope of embodiments legally covered under this patent.

1). The invention of this patent is a form of add-on product for vehicles with a twist stalk instrument control which is composed of the elements of:
an instrument stalk end mounting device,
a stalk extender device with means to make the label clearly visible to the driver at line of sight from the individual driver's head position,
a twistable label holder device which is non-independent in twisting motion from the instrument stalk twisting motion with means to indicate instrument stalk status with the label,
a label for use with the twistable label holder device with means to give driver indication by label when twisted to the instrument on stalk position and which label is hidden from driver line of sight view when twisted to the instrument off stalk position,
with means for giving to drivers an augmented and more reliable control indicator for leaving their vehicle with the head-lights still on especially in the day-time.

2. The invention of claim 1 whereby the instrument stalk first end mounting device has interchangeable parts with different diameters with means to fit different makes and models of vehicles with a second end or an opposing end standard diameter with means for further attachment devices.

3. The invention of claim 1 whereby the stalk extender device is composed of snap-on part extensions which first end means of attachment upon the instrument stalk end mounting's outer-most standard diameter, with the second end or opposing end also having a snap-on part extension with means for individual driver customized stalk length extension beyond driver line of sight blockage by the steering wheel.

4. The invention of claim 1 whereby the twistable label holder snaps onto the second end of the outwards most stalk extender device's standard diameter, and furthermore has a ball shelf which is in the gravity counter, horizontal shelf position at the instrument off stalk twist position, and furthermore the shelf is in the gravity free fall, vertical shelf position at the instrument on stalk twist position.

5. The invention of claim 4 whereby the twistable label holder with ball shelf has an optional ball attached by two ends of an adjustable length string which ball drops down with gravity when the vertical shelf position is active with means for hitting the driver's leg upon vehicle exit, furthermore said ball must at that time be restored to the ball shelf in the gravity counter horizontal shelf position only obtained when the driver restores the instrument stalk to the twist off position.

6. The invention of claim 1 whereby the label gives lights on instrument status which is placed visible to the driver in the instrument on stalk twist position and furthermore, the label is not visible to the driver at the instrument off stalk twist position.

7. The invention of claim 1 whereby the instrument stalk first end mounting device has interchangeable parts with different diameters with means to fit different makes and models of vehicles with a second end or an opposing end standard diameter with means for further attachment devices.

8. The invention of claim 7 whereby the stalk extender device is composed of snap-on part extensions which first end means of attachment upon the instrument stalk end mounting's outer-most standard diameter, with the second end or opposing end also having a snap-on part extension with means for individual driver customized stalk length extension beyond driver line of sight blockage by the steering wheel.

9. The invention of claim 7 whereby the twistable label holder snaps onto the second end of the outwards most stalk extender device's standard diameter.

10. The invention of claim 9 whereby the twistable label holder twists in dependent motion with the instrument stalk with means for giving instrument stalk status.

11. The invention of claim 7 whereby the label gives lights on instrument status which is placed fully visible to the driver in the instrument on stalk twist position and furthermore, the label is not fully visible to the driver at the instrument off stalk twist position.

12). The invention of this patent is a form of add-on product for the first alternative embodiment for vehicles with a sport's equipment roof-rack carrying items such as bicycles with a twist stalk instrument control which is composed of the elements of:
an instrument stalk end mounting device,
a stalk extender device to make the label visible to the driver from variable line of sight of his head past the steering wheel,
a twistable label holder device with means for holding a label to indicate sport's roof-top rack active use whose twisting motion is independent from the twisting motion of the instrument stalk with means for having no logical connection to the instrument stalk status,
a label for use with the twistable label holder device with means to give driver indication of sport's roof-top rack active use when twisted on totally independent of the instrument on twisted stalk position and which label is hidden from driver view when twisted to the off position which is also totally independent of the instrument off twisted stalk position,
with means for giving the drivers an augmented and more reliable control indicator for reminding drivers that a sports roof-rack still has items attached and loaded such as a first means of bicycles, a second means of sports equipment loaded which might collide with a low overhang such as a garage door or underground parking overhang.

13. The invention of claim 12 whereby the instrument stalk end mounting device's first end has interchangeable parts with different diameters to fit different makes and models of vehicles with the second end or opposing end being of a standard diameter with a snap-on end.

14. The invention of claim 12 whereby the stalk extender device is composed of multiple snap-on part length modular extensions of a standard diameter which first end attach upon the second end of the instrument stalk end mounting device with a standard diameter.

15. The invention of claim 12 whereby a twistable two label holder snaps onto the outwards most stalk extender device's second end with means for the first position twist label holder without a ball shelf to hold a ‘lights on!!!!’ type of label fully visible to the driver when in the instrument on dependent to the stalk twist position and is not fully visible to the driver when in the instrument off dependent to the stalk twist position, while, the second position twist label holder for a sports equipment loaded label has the duo-indicator use which uses independent twist motion to the instrument stalk twist position.

16. The invention of claim 12 whereby a twistable label holder with ball shelf snaps onto the standard diameter of the second end or outwards end of the outermost stalk extender device and has a ball shelf which is furthermore in the gravity countering horizontal shelf twist position independent of the instrument off stalk twist position, and is furthermore in the gravity free fall vertical shelf twist position independent of the instrument on stalk twist position with means for use as a sport's equipment loaded indicator only.

17. The invention of claim 16 whereby the twistable label holder with ball shelf has an optional dangling ball attached with the two ends of an adjustable length string which drops down with gravity from a vertical ball shelf position with means for hitting the driver's leg upon vehicle exit, which ball must at that time be driver restored to the horizontal ball shelf in the gravity counter twist position obtained independently of the instrument stalk position.

18. The invention of claim 17 whereby the ball is attached by an adjustable length string to the twistable label holder with ball shelf.

19. The invention of claim 16 whereby the label indicates sports equipment on status with means for being clearly readable by the driver in the twist on position which is independent of the instrument on stalk twist position, furthermore with means for having letters not being fully readable by the driver at the twist off position which is independent of the instrument off stalk twist position.
